(19) United States
(12) Patent Application Publication
(10) Pub. No.: US 2023/0225361 A1
(43) Pub. Date: Jul. 20, 2023

(54) INJECTION MOLDING OF MEAT-LIKE FOOD PRODUCTS

(71) Applicant: YISSUM RESEARCH DEVELOPMENT COMPANY OF THE HEBREW UNIVERSITY OF JERUSALEM LTD., Jerusalem (IL)

(72) Inventors: Yaakov NAHMIAS, Rishon Le Zion (IL); Mohammad GHOSHEH, Jerusalem (IL)

(21) Appl. No.: 18/007,152

(22) PCT Filed: Jul. 27, 2021
(86) PCT No.: PCT/IL2021/050906

§ 371 Date: Jan. 27, 2023

Related U.S. Application Data
(60) Provisional application No. 63/057,663, filed on Jul. 28, 2020.

(51) Int. Cl. A23J 3/22; A23J 3/26; A23P 30/20; A23P 30/10

(52) U.S. Cl. CPC A23J 3/227; A23J 3/26; A23P 30/10; A23P 30/20

(57) ABSTRACT

The technology disclosed herein concerns a process and system for producing a multi- sectional food product having an external shape and a plurality of internal sections.

### TECHNOLOGICAL FIELD

The invention generally concerns a method and system for injection molding of food products.

### BACKGROUND

The demand for protein is increasing worldwide while global animal agriculture is at maximal capacity. Current approaches to deal with this shortage involve the use of plant-based textured protein to make minced meat-type products such as burgers, hotdogs and nuggets. However, the demand for steak mimicking products remains unmet. One of the main reasons for this yet unmet need resides in the fact that unlike other food products which are composed of a mixture of food ingredients that are processed together; a steak comprises regions of different materials.

While several 3D printing methods have been proposed for making steaks, none of these techniques is truly capable of producing a product that sufficiently resembles the original and which can be produced in a scalable way.

### GENERAL DESCRIPTION

The inventors of the technology disclosed herein have developed a continuous high-throughput injection molding process for producing food products, in general, that contain different types of materials, each occupying a different region in the product, and food products that mimic meat products. A steak, for example, containing four different types of materials: bone, muscle, connective tissues and fat was successfully produced by the technology of the invention, mimicking not only the visuality of the steak but also its texture and mouth feel.

Processes of the invention find superiority in the continuous production of meat-like products that are composed of regions of different materials. Thus, processes of the invention may be continues processes or batch processes. Processes of the invention are mainly directed to such products and exclude confectionary products (either sweet or savory products), gluten-rich products (such as bread and cakes), chocolate products, candy and bakery products (cakes, bread, savory products and others).

As known in the art, “injection molding” is broadly a technique involving injecting one or more materials (injectants) into or through a shaping tool, e.g., a mold or a die to produce an article with a shape and size governed by the shaping tool. Unlike materials commonly used in injection molding, the injectants utilized in processes of the invention are food components of various sources, e.g., natural or synthetic sources, plant or cell-based sources and others, that replace components from animal sources and which may be tailored to provide a final product with a particular visuality and texture. By utilizing processes of the invention, multiple products of same or different shapes, sizes, material composition, or material distribution may be produced simultaneously.

One advantage of the injection molding process of the invention over available processes to produce meat-like structures from plant proteins is fiber orientation. Processes of the invention involve low or high moisture extrusion processes carried out at appropriately low or high temperatures to align denatured proteins through a small nozzle under high pressure. The material can be expanded in one direction creating vertically aligned fibers, e.g., reminiscent of chicken breast. While available 3D printing processes similarly enable extrusion of fibers that are layered vertically with the surface, to obtain a product with oriented fibers, the process must print a thick chunk of the meat and cut it vertically to produce aligned fibers. Shear cell technology faces similar problems as the spinning melt aligns the fibers with a rotating drum. This vertical fiber orientation complicates mass production as it is not conducive for assembly line automation.

Thus, in its most general aspect, the invention provides a process for producing a multi-sectional food product having an external shape and a plurality of internal sections, the process comprising simultaneously or sequentially injecting into a shaping tool having a plurality of cavities, a plurality (one or more) of food components, such that each of the plurality of food components occupies a different cavity within the tool.

The multi-sectional food product is a consumable product having at least two distinct regions or sections that are associated to each other (directly or indirectly) within the product. The at least two distinct regions or sections are composed of same or different components. Where the food product produced by processes of the invention is intended to resemble or mimic a known product derived from, e.g., an animal source, such as a steak, the visual and textural characteristics of the product may be maintained, but their composition may be different. In accordance with the invention, fat, protein, bone, hydrocarbons, connective tissues, muscle and other meat-based components that are distinct to products derived from animal sources may be replaced with synthetic or semi-synthetic food components or components derived from plants or cells. Non-limiting examples of such known products that can be mimicked utilizing processes of the invention include steaks of all types, including but not limited to whole cuts of beef, pork and lamb, such as ribeye, filet, T-bone, sirloin, flat iron, lamb or pork chop, loin, or rack.

Products produced by processes of the invention exclude confectionary products (either sweet or savory products), gluten-rich products (such as bread and cakes), chocolate and chocolate products, candy and bakery products (cakes, bread, savory products and others).

The shaping tool used in accordance with the invention is typically assembled prior to manufacturing or during the manufacturing processes, by providing an external mold having a cavity in a shape defining the outer perimeter shape and size of the food product to be produced and one or more additional molds, so-called internal molds or internal cavities, that are structured as frames and configured to occupy a region within the perimeter of the cavity of the external mold. Each of these internal molds is used to define a material section within the eventually produced food product. Notwithstanding the shape and size of the shaping tool, it may be produced from any material suitable for the purposes of the invention. Such materials may be metal, e.g., steel, aluminum and others; ceramic materials; polymeric materials; glass; and others.

The shaping tool may be a single die or mold element comprising an external mold which determines the external perimeter size and shape of the product to be manufactured and which is configured to permit positioning or receiving one or more internal molds within the cavity perimeter or may be provided with one or more internal structures defining the plurality of different material sections in the product. The one of more internal structures may be formed by molds of smaller sizes, selected shapes and volumes. They may or may not be an integral part of the external mold. Each of the internal molds or a group of internal molds may be provided with a separate injection port through which an injectant may be delivered. In some cases, the internal molds may be provided separately, as one or more individual structures, or may be provided as a single externally fused structure having an internal division defining the internal molds. Each of these structures may be associated with a different injection port through which an injectant may be delivered.

Thus, in some embodiments, the shaping tool may be provided as an assembly of one or more dies or molds, wherein each mold shapes a different section of the product, and wherein the one or more dies or molds are stacked or assembled to provide a complete shaping tool. In some exemplary embodiments, a shaping tool assembly may comprise a meat die and a fat die, wherein the meat die shapes the internal sections (internal molds) of the food product, wherein each of the sections may be injected with the same or different food component (or meat component), and the fat die permits directing fat to the side faces of the product and to cavities formed between the various internal sections, to thereby connect the internal sections and set the size and shape of the final product (by forming a fat layer in the product side faces). In other words, the injectants need not be delivered or injected into the shaping tool from a direction that is substantially perpendicular to the planer face of the tool; but may additionally or alternatively be configured and operable to be injected from the tool sides (to the side faces of the produced product).

In an exemplary process of the invention, the process involves a food extrusion of protein and fat mixture. The extrusion may be high and/or low moisture extrusion. High moisture extrusion (wet extrusion) process enables texturizing vegetable protein into a product with fibrous texture, as animal meat. High moisture extrusion involves high moisture content generally being above 40% and elevated temperatures, e.g., above 100° C. This process is different from conventional low-moisture extrusion which utilizes much smaller amounts of moisture content, generally below 40% or even below 30%. By extrusion the protein and fat together, a viscoelastic muscle-like protein melt is obtained that mimics an intramuscular fat woven amongst protein fibers and sheaths. The muscle-like protein melt is continuously flown in a direction optionally perpendicular to a shaping tool and perpendicularly injected into the shaping tool. While flown in the direction of the shaping tool through a chamber, e.g., an elongated barrel, having an input at the end proximal to the extruder and an output at the end entry to the shaping tool, the melt may be heated or cooled such that the melt is injected into the shaping tool at a predetermined temperature.

The system temperature or extruder temperature or the material injection temperature may be a “high temperature” ranging between 40 and 300° C. or between 80 300° C. or between 85 and 270° C.; or may be a “low temperature” ranging between -80 and 4° C. In some embodiments, the high temperature is above 100° C. In some embodiments, the low temperature is below 0° C.

The shaping tool comprises two or more molds or dies arranged along the path of the material (melt) flow, and at the output of the chamber, e.g., elongated barrel. One of the molds or dies is positioned proximal to a chamber containing the melt to be injected and another of the molds or dies is situated distal or further away from the chamber. The proximal mold or die defines an input mold and the distal mold defines an output mold from which the final product flows. Additional molds or dies may be positioned between the proximal and distal molds. The shaping tool is assembled such that the proximal mold is shaped to define some or all of the internal sections of the meat-like product, and distal mold is shaped to define the final product external perimeter size and shape.

Thus, the melt exiting the chamber, e.g., barrel, is injected into the proximal mold allowing formation of muscle-like regions inside the internal mold cavities. As the material continues to flow, the shaped material enters into the next mold, e.g., being for example the distal mold (in case the shaping tool comprises two molds or dies), with the shapes, sizes and relative positions of the muscle-like regions being maintained. Simultaneously with or sequentially to the passing into the distal mold, to fill the gaps formed between the meat-like regions, fat, e.g., proteoleogel fat, may be interfacially injected into the distal mold through designated one or more fat ports positioned at an interface of the shaping tool. Thus, in some embodiments, the direction of the fat flown into the mold is not perpendicular to the face of the shaping tool but rather substantially perpendicular to the flow of the melt. Thereby, fat is distributed in a harmonic flow within the molded muscle-like regions, forming a layer around the muscle-like regions of the melt and filling the vacant spaces between the molded regions, mimicking intermuscular and subcutaneous fat. The, e.g., proteoleogel filling assists in binding the meat sections together. The intermuscular fat may be solidified and allowed to bind to the protein chunks taking the advantage of the extruded melt temperature. The meat-like molded product then undergoes cooling and is cut or sliced to provide the final boneless whole cut steak.

In a similar fashion to the addition of fat components from designated fat port(s), bone cement may be injected into a further mold designated within the shaping tool to structure the bone region(s). The cement may be injected under heating or cooling conditions, simultaneously with a material mimicking connective tissues.

Boneless steaks such as whole cut steaks such as Ribeye, Steak strip, Sirloin, and Denver Cut may be prepared by processes of the invention. Similarly, bone-containing steaks such as whole cut of Rib-eye steaks, T-bone, Porterhouse, Tri-Tip New York Strip, Flank, Flat Iron and Hanger steaks may be manufactured by processes of the invention.

Thus, the invention provides a process for producing a multi-sectional meat-like product having an external shape and a plurality of internal sections, the process comprising
injecting at least one food component into a shaping tool having a plurality of spaced apart cavities within an external perimeter of the shaping tool;
injecting at least one other food component into a space defined by a distance between the spaced apart cavities and onto the external perimeter of the cavities;
to thereby obtain the meat-like product.

In some embodiments, the shaping tool comprises one or more mold structures. In some embodiments, a first of the mold structures defines the external perimeter shape and size of the meat-like product and another of the mold structures defines one or more internal sections (the muscle-like sections) of the meat-like product, wherein the shaping tool allows for manufacturing of a meat-like product having an external shape and size defined by the first of the mold structures and a plurality of internal sections of predetermined shapes and sizes that are each defined by another of the mold structures. The first and another mold structure defining together the shaping tool, are not necessarily the first and last mold structures in the shaping tools. They may be two molds in a series of mold structures, wherein the above ‘first’ mold structure is not necessarily the first in the sequence of mold structures.

In some embodiments, the process comprising obtaining a shaping tool comprising two or more mold structures or dies arranged along a path of a material flow, wherein one of the mold structures defining an external shape and size of a meat-like product to be manufactured and another of the mold structures having cavities within a region defined by the shape and size of the meat-like product, the cavities defining different material sections for the muscle-like materials within the meat-like product.

In some embodiments, the process comprises
injecting at least one food component into a shaping tool comprising two or more mold structures, each being arranged along a flow path of the at least one food component to fill cavities within a region defined by a shape and size of the meat-like product.

In some embodiments, the process comprises
injecting at least one other food component into a space defined by a distance between the cavities and onto the external perimeter of the cavities filled up with the at least one food components.

In some embodiments, the shaping tool is assembled of two or more individual molds or dies, each having a cavity profile defining a different section of the food products, wherein the sum of all cavity profiles is within a perimeter defined by a size and shape of the product to be manufactured. As used herein, the “cavity profile” comprises one or more of cavity size, shape, position, number of cavities, and distance between cavities.

In some embodiments, the shaping tool comprises a plurality of material input ports, wherein each port is configured and operable to deliver into the two or more mold structures same or different food components. In some embodiments, one or more of the material input ports are positioned to allow perpendicular delivery of a food component into the mold structures. In some embodiments, one or more of the material input ports are positioned to allow peripheral delivery (not perpendicular delivery) of a food component. In other words, a shaping tool is provided with a plurality of input ports, some positioned to permit perpendicular delivery of food components into the molds and some positioned peripherally. As used herein, a muscle-like material input port is positioned, configured and operable to perpendicularly deliver a protein melt or protein mixture melt, as defined herein. A fat input port is positioned, configured and operable to peripherally deliver fat. A bone-cement input port is positioned, configured and operable to deliver bone cement into the shaping tool.

In some embodiments, the at least one food component is a protein or a fat or a mixture thereof, wherein one or both components are flown in a melt form. In some embodiments, the at least one food component is a mixture of protein and fat (the so-called muscle-like material).

In some embodiments, the at least one other food component is fat or bone cement.

In some embodiments, at least one of the food components is injected via a high-moisture extruder enabling injection of a food component to forms aligned fibers.

The invention also provides a process for producing a multi-sectional meat-like product having an external shape and a plurality of internal sections, the process comprising
providing a shaping tool or a system comprising same, the tool having a plurality of spaced apart cavities within an external perimeter thereof and provided with one or more muscle-like material input ports and one or more fat input ports, and optionally one or more bone cement input ports;
flowing via one or more of the muscle-like material input ports a melt mixture of protein and fat to thereby fill said cavities with the melt mixture;
flowing via one or more of the fat input ports fat to thereby fill spaces defined by distances between the cavities and onto an external perimeter of the cavities;
to thereby obtain the meat-like boneless product.

In some embodiments, the process further comprises flowing via one or more of the bone cement input ports a bone cement to thereby form a bone-like region within the meat-like product, yielding a bone-containing meat-like product.

The food components, e.g., fat and protein, may be combined together in a single or twin-screw extruder, which may be low or high moisture, low or high temperature extruder, as defined herein, selected to inject the food components, e.g., a protein melt, a rehydrated textured vegetable protein, a rehydrated textured vegetable protein mixed with fat, or a meat-based component (i.e., the muscle-like material). In some embodiments, the muscle-like material is injected as a predetermined temperature and constitution with the help of a pump such as a pneumatic, a peristaltic, a positive-displacement, a centrifugal, or an axial-flow pump.

In some embodiments, the muscle-like material, e.g., fat and protein or fat or protein alone may be maintained at a temperature between 0-65° C. This temperature is maintained in the pump as well. The discharge pressure may be between 0.1-100 Bar.

The extruder may be operated at a high temperature, as defined. In some embodiments, the high temperature is between 40 and 300° C. In some embodiments, the extruder may be operated at a low temperature, as defined. In some embodiments, the low temperature is between -80 and 4° C.

The extruder pressure may range between 1-1000 Bars.

Alternatively a single screw or a power heater extruder may be utilized. The power heater may be operated at a temperature between 50 and 100° C. or around about 65° C., for extruding textured proteins, hydrated or dehydrated, or mixture or combinations comprising same.

In some embodiments, a high-moisture extruder is utilized for injection of a protein component to form aligned fibers.

In some embodiments, a powder heater extruder is utilized for injection of a protein component to align fibers. In some embodiments, the protein component is textured protein.

The meat-like food product obtained by injection molding may be post treated to endow the product with one or more mechanical, textural, visual or other properties relating to the product shelf-life and commerciality. In some cases, the product may be thermally treated or irradiated with light of certain wavelengths. The thermal and irradiation treatments do not typically cause effective cooking of the product. Where any such post treatment is needed, it may be applied to the product as a whole or to any region or section thereof. Post treatment may be achieved while molding, after each section has been formed, after the complete product has been molded or simultaneously and continuously with the injection of the food components.

The food components filling up the mold or any of the internal molds are derived from plant sources or may be cell-based materials. These materials may be selected from fats, carbohydrates, fibrous materials and roughages, proteins, cell suspensions, animal byproducts, polymers, salts and others. In some cases, the food components may also be selected amongst ceramic, cement and carbonaceous materials or other materials which can mimic bone structures (herein bone-cement).

As known in the art, fats are typically esters of long chain fatty acids and an alcohol, such as glycerol. They may be presented as single materials or in composition with other materials, wherein the composition is typically a solid or semi-solid composition or an oleogel. Fats utilized in the production of food products of the invention may be derived from dairy products or from plant sources. The fats may be saturated fatty acids, monosaturated fatty acids or unsaturated fatty acids. Sources of fats may include butter (for example butyric acid), animal fats (such as stearic acid) and plant derived fats (such as octanoic acid, oleic acid and others). Non-limiting examples of fats which may be used according to the invention include palm oil, coconut oil, olive oil, soy oil, canola oil, flex seed oil, peanut oil, safflower oil and other edible oils.

Alternatively, the fat may be derived from an animal source, for example ground or rendered animal fat, or cultured fat growing from stem cells, mesenchymal cells, or fibroblasts or cultured adipocytes.

The fat used in molding of products of the invention can be formed into an oleogel or other emulsions that form gels at room temperature.

The carbohydrates are typically obtained from plants sources such as wheat, rice maize, potatoes, sago, peas, beans and fruits.

Fibrous materials and roughages may also be obtained from plants, mainly vegetables and fruit with skin high in fiber content.

Proteins may be provided from various sources, including plant sources and animal sources. Plant proteins may be obtained from nuts, beans, whole cereals such as wheat and maize, legume, pulses soy, chickpeas, peas, rice, lentil and others. Proteins may also be microorganism-based and may be, for example, mushroom proteins such as yeast or shitake, mold such as fusarium venenatum, algae, fungi, yeast, bacteria or archaea. Some sources of animal proteins include fat-free meat or lean meat, fish, eggs, milk and cheese.

In some embodiments, protein is derived from cultured cells growing from stem cells, mesenchymal cells, satellite cells, fibroblasts or cultured muscle cells.

The oleogel is an aqueous-based oil-containing gel which comprises a gelling agent, at least one oil, and a protein.

In some embodiments, the gelling agent is a cellulose derivative.

In some embodiments, the gelling agent is a fibrous material.

In some embodiments, the gelling agent is methyl cellulose, carboxymethyl cellulose, hydroxypropyl methylcellulose, ethyl cellulose, ethyl methyl cellulose, hydroxypropyl cellulose, hydroxyethyl cellulose, poloxamer, gelatin or citrus fiber. In some embodiments, the gelling agent is methyl cellulose.

In some embodiments, the at least one oil is any of the edible oils mentioned herein. In some embodiments, the at least one oil is palm oil, coconut oil, olive oil, soy oil, canola oil, flex seed oil, peanut oil, safflower oil or any other edible oil.

The protein used in an oleogel is any of the proteins defined herein.

In some embodiments, the oleogel of the invention comprises methylcellulose and canola oil and water. In some embodiments, the oleogel comprises at least one protein, thus forming a protein-based oleogel (proteoleogel). In some embodiments, the protein is derived from chickpea, soybean, pea, mung bean, lentil, potato or rice.

In some embodiments, the proteoleogel has a viscosity value (G′ and G″) greater than 500 Pa.

In some embodiments, a proteoleogel of the invention comprises methylcellulose in an mount between 1 and 5% w/w, (in some embodiments- 3%), canola oil in an amount between 20 and 40% w/w (in some embodiments- 30% w/w) and protein in an amount between 1 and 5% w/w (in some embodiments- 3% w/w).

The proteoleogel of the invention may be used for as a fat substitute.

The proteoleogel of the invention may further be used as an adhesive material for fat or fat/protein mixtures.

In another aspect, there is provided an extrusion system, the system being, in some embodiments, used for manufacturing a meat-like product, the system comprising:
a single or twin-screw extruder, configured to operate at a low or high moisture, as defined, and/or low or high temperature, as defined, and extrude at least one food component, such as a protein melt, a textured vegetable protein (being hydrated or dehydrated), a rehydrated textured vegetable protein mixed with fat, or a meat-based component into a shaping tool;
a chamber, e.g., in a form of a barrel, such as an elongated barrel, configured to receive the at least one food component from said extruder and deliver same into the shaping tool; and
a shaping tool in a form of a die or a mold or an assembly thereof.

In some embodiments, the single or twin-screw extruder operating at a low or high moisture, as defined, and/or low or high temperature, as defined, may be operated at a between 40-300° C. In some embodiments, the low moisture extruder operates at a humidity that is below 35%, or below 40%. In some embodiments, the high moisture extruder is operated at a temperature above 40° C.

In some embodiments, the extruder is a single screw extruder.

In some embodiments, the single screw extruder is a power heater extruder, operated at a low or high moisture, as defined herein, and at a temperature around 50 and 75° C. In some embodiments, the temperature is around 65° C.

In some embodiments, the shaping tool comprises two or more mold structures or dies arranged along a path of a material flow, wherein one of the mold structures defining an external shape and size of a meat-like product to be manufactured and another of the mold structures having cavities within a region defined by the shape of the meat-like product, the cavities defining different material sections within the meat-like product.

In some embodiments, the shaping tool is provided with one or more meat input ports, one or more fat input ports and optionally one or more bone-cement input ports.

In some embodiments, the one or more meat input ports are provided to allow perpendicular flow of the at least one food component from the barrel into the shaping tool.

In some embodiments, the one or more fat input ports and bone-cement input ports are positioned peripherally on the shaping tool allowing for peripheral flow of the fat or bone cement.

The system further comprises at least one pump for injecting the at least one food component into the shaping tool. The at least one pump may be a pneumatic, a peristaltic, a positive-displacement, a centrifugal, or an axial-flow pump.

The invention further provides a system for injection molding at least one food product, as defined herein. The system generally comprises two or more stations positioned over and in proximity of a belt system configured to move, carry and transport molds for forming the food products. The belt system is optionally temperature controlled. Each of the two or more stations are configured to inject a particular food component into a preset section of the mold. The system is further provided with a computer and a user interface enabling system operation.

Any one of the two or more stations may be equipped with a high-moisture extruder that enables injection of a food component, e.g., a protein, in a way that forms aligned fibers.

The system may further comprise a cooling station.

In some embodiments, the invention provides a system for injection molding at least one food product, the system comprising two or more stations positioned over and in proximity of a belt system configured to move, carry and transport molds for forming the food products, the belt system being optionally temperature controlled;

wherein each of the two or more stations is provided with an extruder configured to inject a food component into a preset section of the mold, at least one of the two or more stations is provided with a high-moisture extruder enabling injection of a food component to forms aligned fibers.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a computer-aided design (CAD) of a beef entrecote steak, showing assembled multiple muscle segment, fat, and ribeye bone.

FIG. 2 shows a muscle mold CAD design.

FIG. 3 shows a flexible material (AGILUS30) which was used to 3D print the mold.

FIG. 4 shows a CAD design of beef entrecote ribeye bone.

FIG. 5 shows a plurality of 3D printed ribeye bones formed of biocompatible ceramic materials.

FIGS. 6A-B show explosive view of an exemplary shaping tool assembly: a top view is shown in FIG. 6A. From bottom to top: bottom mold, edible ceramic-based bone, protein injection mold and fat mold. FIG. 6B shows a side-view of the shaping tool components.

FIGS. 7A-B provide an assembled view of the shaping tool components.

FIG. 8 provides a photo of a prepared steak according to the invention.

FIG. 9 provides a schematic design of an automated production line according to some embodiments of the invention.

FIG. 10 provides a schematic depiction of a system according to the invention for the continuous production of meat-like products.

FIGS. 11A-C are schematics of mold structures. FIG. 11A presents a mold structure with the various cavities defining material regions in the final meat-like product. FIG. 11B presents a schematic of an actual mold. FIG. 11C shows an assembly of material ports through which a material is injected into the mold of FIG. 11B. FIG. 11D shows a schematic of another mold structure defining shape and size of the product to be produced.

FIG. 12 shows a depiction of an assembled shaping tool.

FIGS. 13A-B show: (A) Consistency and color of animal fat (beef and lamb) compared to oleogel and different proteoleogels comprising of different plant proteins (B) Shape and consistency of oleogel (left) compared to proteoleogel (right) grilled at temperatures above 230-260° C.

FIG. 14 shows Left: Grilled injection molded steak composed of soybean protein and soybean protein canola oil-based proteoleogel. Right: Cross section of grilled steak showing Intramuscular (green arrows), intermuscular (white arrows) plant-based fat and the injected plant-based meat (blue arrows)

FIGS. 15A-B show (A) Rheometer used to investigate shear rheology, shear moduli and yielding behavior of standard oleogel, proteoleogels and animal raw fats (B) Rheological properties of edible pre-cooked oleogels with different protein compositions (proteoleogel) compared to standard oleogel and raw animal fat showing 2-3-fold increase in storage modulus (G′) and loss modulus (G″) of proteoleogel compared to standard oleogel.

### DETAILED DESCRIPTION OF EMBODIMENTS

Assembly starts on a temperature-controlled surface (e.g. stainless steel). In products that include bone, like ribeye or T-bone steak, a ceramic bone is either placed on the surface or injected into a bone mold using bone cement.

In the next step a muscle mold comes down on the surface and protein is injected through multiple ports (in a single or multiple stations); at least one port for each muscle segment. The injected material can comprise of a plant protein (e.g. soy, pea, and wheat), fungi protein (e.g. mushroom protein, mold protein) or cell-based protein (e.g. animal protein or cultured animal cells). To create a fibrous structure that is aligned vertically, the protein mixture can be injected through an extruder (e.g. high moisture extruder, power heater) perpendicular to the surface. Injected protein would be stabilized by controlling the surface temperature. The mold would then lift, and the conveyor belt moved to the next step.

In the next stage, a fat mold descends on the product and fat is injected into the holes, cracks, spaces between the protein sections. The injected fat can be plant-based fat that is solid at room temperature (e.g. palm oil, coconut oil), oleogel composed of fatty acids and gelling agents such as methyl cellulose, in some embodiments, in combination with a protein (i.e. proteoleogel), or cell-based fat (e.g. rendered animal fat or cultured animal cells). Injected fat can be stabilized by controlling the surface temperature. The mold would then lift, and the conveyor belt moved to the next step.

In the next step, the injected molds are cooled in a cooling station where the product is removed from its mold and cooled before packing and shipment.

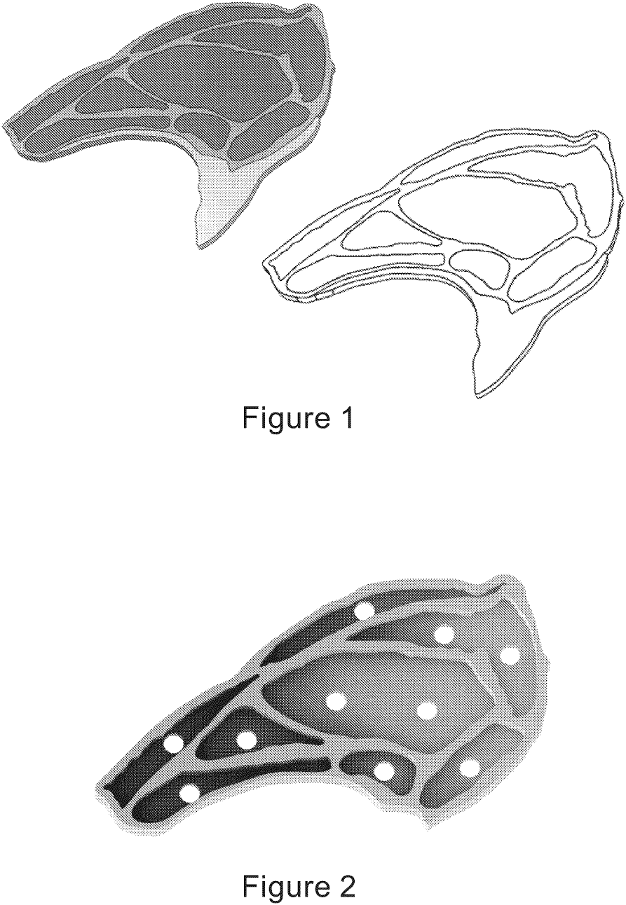

A computer-aided design (CAD) of a beef entrecote steak, showing assembled multiple muscle segment, fat, and ribeye bone is shown in FIG. 1. The design was created using CAD software (SolidWorks®, USA) as a requirement of the 3DP process. 3D printing was later performed either by Polyjet or ColorJet 3D printing method.

A muscle mold CAD design is shown in FIG. 2. Following the design process, the muscle mold CAD file was exported as sldprt format. The 3DP method used to print the mold was Polyjet printing technique.

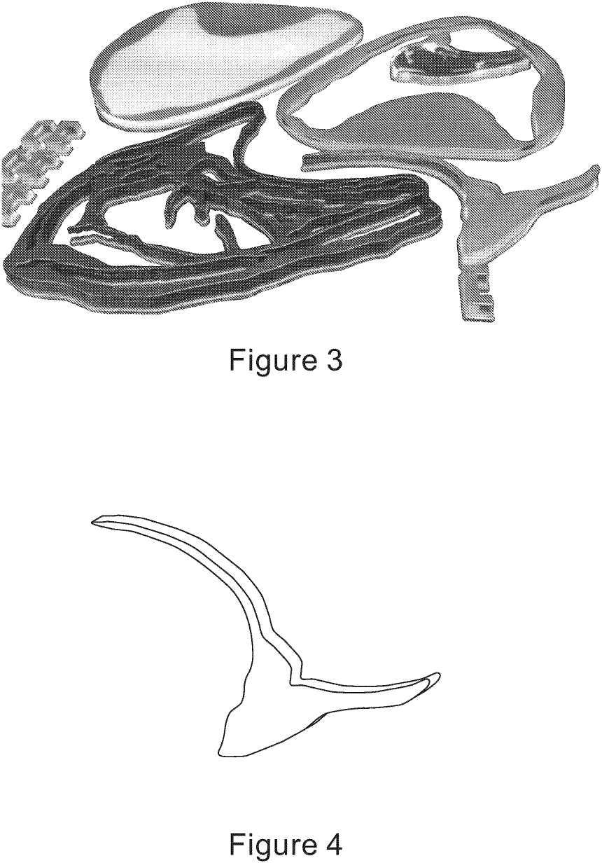

FIG. 3 shows a flexible material (AGILUS30) which was used to 3D print the mold. AGILUS30 were loaded into Polyjet 3D printer (CONNEX3 OBJET260). The flexibility was set at 30% shore hardness. In a process of the invention, the 3D printed mold is positioned on the surface and then injected with a protein mixture through multiple ports forming muscle segment, as explained herein.

FIG. 4 shows a CAD design of beef entrecote ribeye bone.

Following the design process, the bones were exported as STL (surface tessellation language, stereolithography), which is the file format allowing to define 3D models using just triangle meshes. The 3DP method considered is a powder-based ink-jet printing technique. This technology is useful for printing bone because a variety of powders including ceramic.

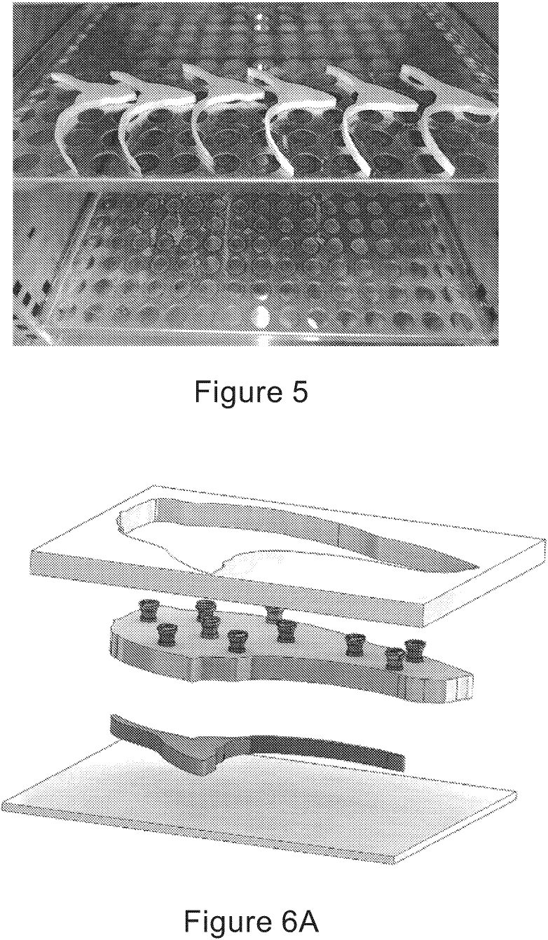

A plurality of 3D printed ribeye bones formed of biocompatible ceramic materials is shown in FIG. 5.

Powder-based 3D printing is characterized by using a powder bed to provide raw material, and binding powders together by polymer glue or other thermal fusion methods. Calcium carbonate powders were loaded into Powder ColorJet (CJP) 3D printer (Projet 160, 3D Systems, USA). CSHH and 2-pyrrolidone (water-based binder) were the main consumables of the 3DP process. 3D printing was conducted at constant binder saturation at 90% and layer thickness of 0.1 mm. At the end of the printing process, the bones were removed from the building platform at ambient temperature. Next, bones were sintered and baked at 80° C. in an oven. The bones were then ready to be fused by sintering and to be sprayed by biocompatible glue.

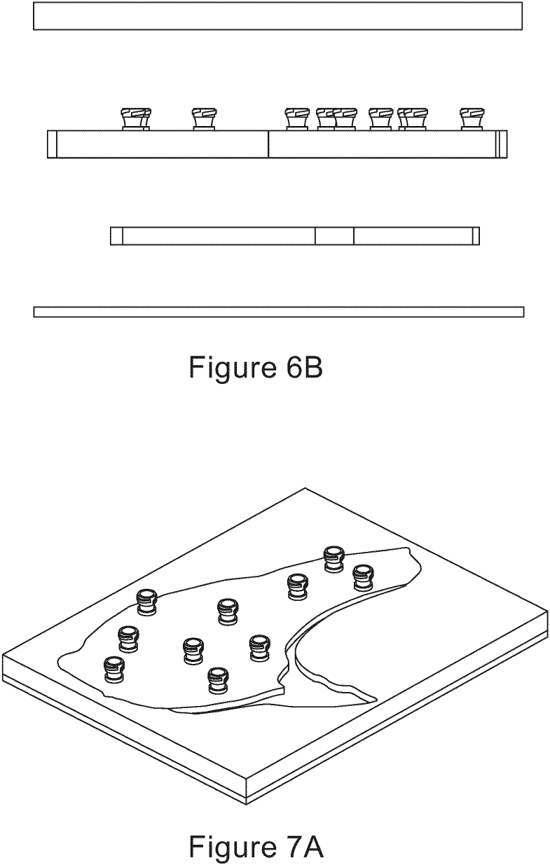

Explosive view of the system components is shown in FIG. 6A. From bottom to top: bottom mold, edible ceramic-based bone, protein injection mold and top mold. FIG. 6B shows a side-view of the injection molding system.

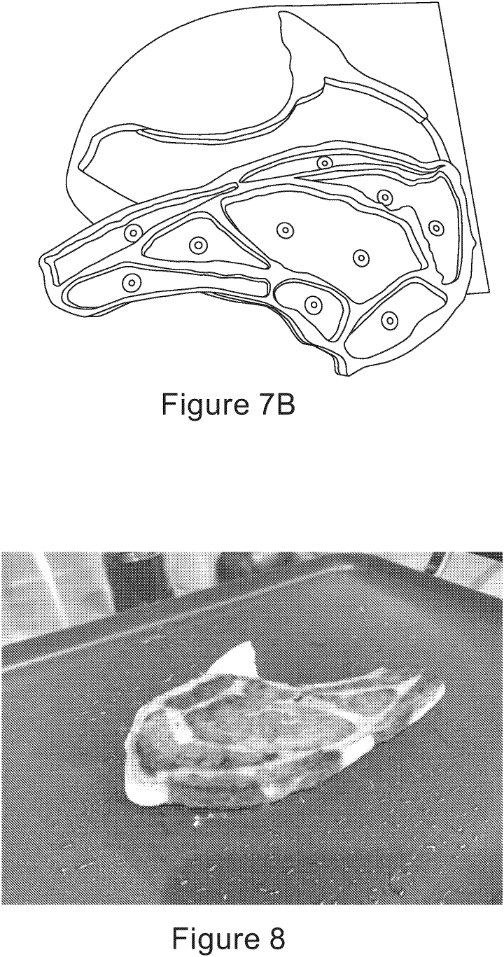

Assembled view of the shaping tool components is shown in FIG. 7A. The mold is placed down on the bottom lid and the bone is placed on the bottom mold. Protein is injected through multiple ports to form muscle segments. The mold is then lifted, the next step is to inject the fat towards the cracks, forming fat between the muscle segments by the same thickness. The mold is then lifted and the steak is cooled. 3D printed mold is shown in FIG. 7B and in FIG. 8.

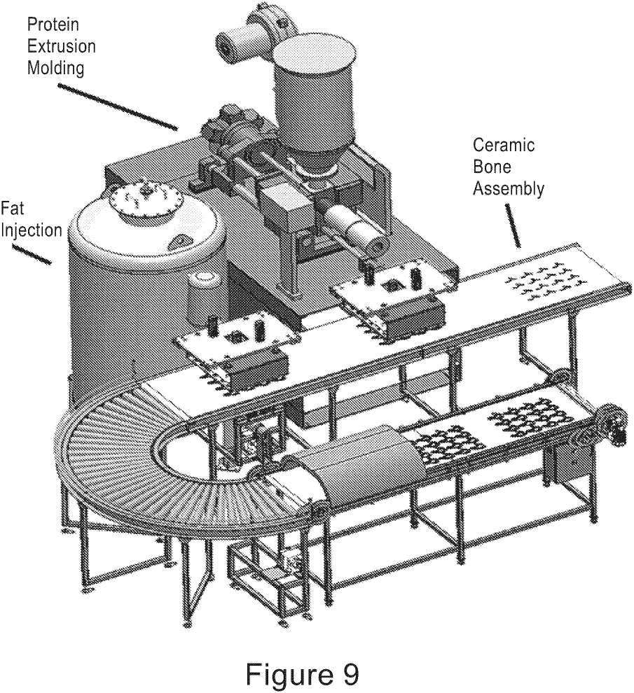

A schematic design of a concept automated production line is shown in FIG. 9. Assembly line conveyor belt starts with a ceramic bone assembly space, followed by a protein injection station fed through high moisture extruder. Fat injection takes place in a third station on the line, at which point the product is either frozen or cooked. Such a production line is theoretically capable of producing up to 5,000 kg/day of plant-based steaks.

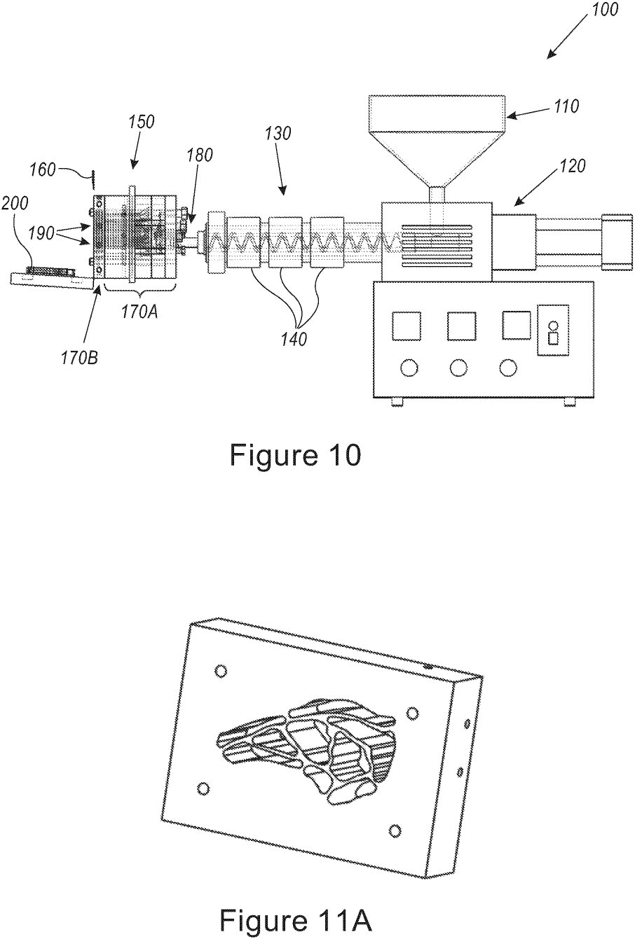

FIG. 10 depicts another system according to some embodiments of the invention. The system 100 comprises a meat feed port 110, an extruder 120, a barrel 130 optionally fitted with heating or cooling elements 140, a shaping tool 150 and a cutting tool 160.

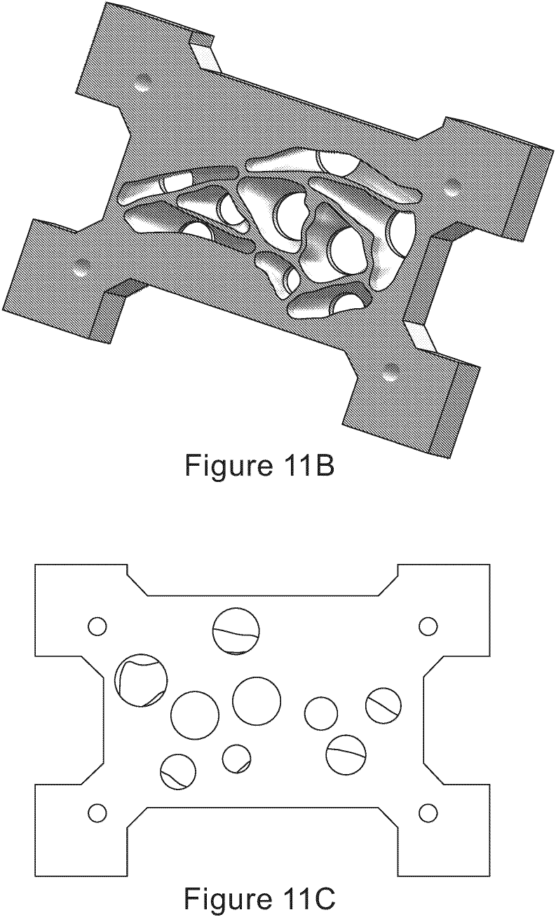

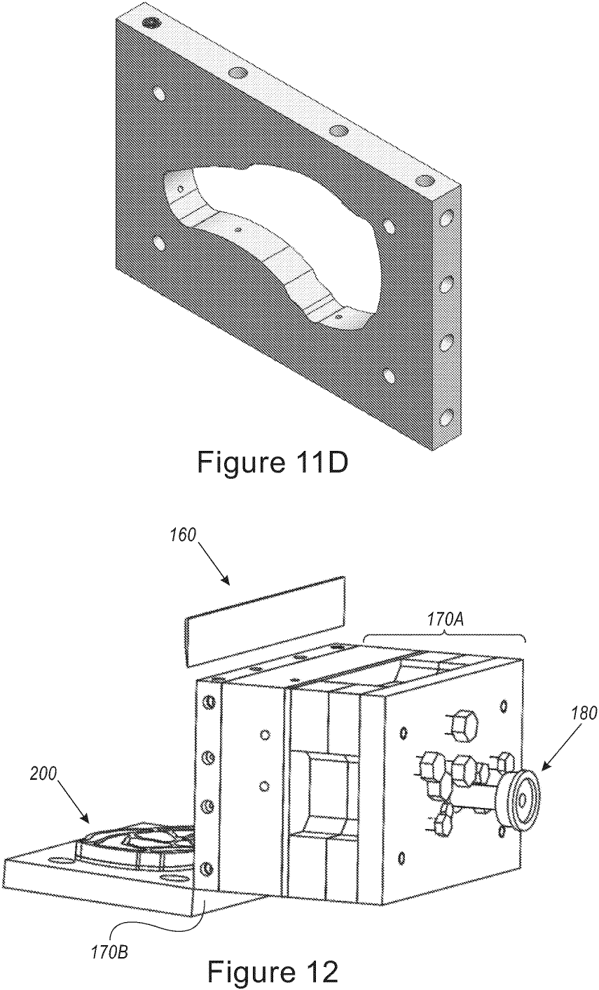

A protein and fat mixture added into the meat food port 110 is extruded and delivered via the extruder barrel 130 in the direction of the shaping tool 150. The shaping tool 150 depicted also in in FIG. 12 comprises two or more molds or dies 170A and 170B arranged along the path of the material (melt) flow. One of the molds or dies 170A is positioned proximal to a barrel 130 containing the melt to be injected and another of the molds or dies 170B is situated distal or further away from the barrel 130. The proximal mold 170A defines an input mold and the distal mold 170B defines an output mold from which the final product exists. Additional molds or dies may be positioned between the proximal and distal molds. The shaping tool 150 is assembled such that the proximal mold 170A is shaped to define some or all of the internal sections of the meat-like product, as depicted in FIGS. 11A and 11B, and distal mold is shaped to define the size and shape of the final product, as depicted in FIG. 11D.

The melt exiting the barrel 130 is injected into the proximal mold 170A via a meat input port 180. Fat is injected into the distal mold 170B via one or more fat input ports 190.

A cutting apparatus or element 160 positioned above the shaping tool is configured to slice the molded meat-like product exiting the shaping tool into a final meat-like product 200.

### Rheological and Texture Measurements of Plant-Based Fats

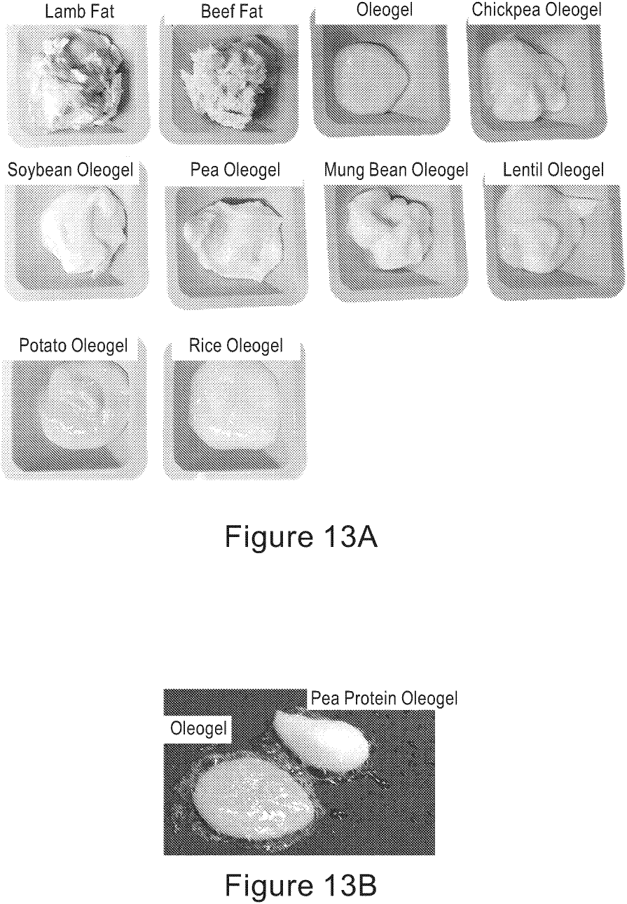

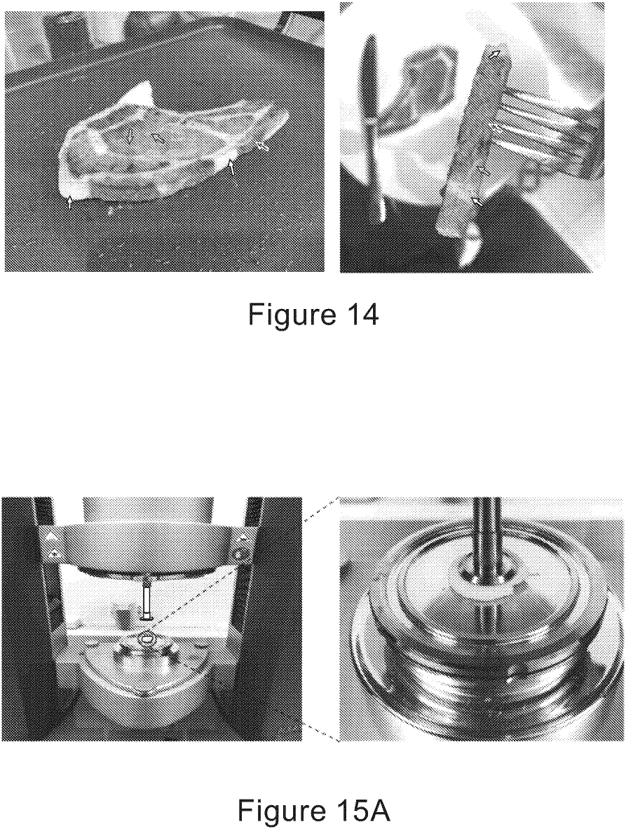

Standard oleogel was prepared by mixing methylcellulose (3% w/w) and canola oil (30% w/w) in water. The oleogel did not have the right mechanical adhesive property to hold the extruded meat segments together. In order to improve the adhesiveness and stiffness of oleogel, different combinations of protein-based oleogel (protoleogles) were prepared by mixing (3% w/w) of methylcellulose, canola oil (30% w/w) and protein (3% w/w): chickpea, soybean, pea, mung bean, lentil, potato and rice in water, creating proteoleogels with different texture and stiffness (FIG. 13A). Heating of the different fat and fat-like materials showed that consistency and structural stability of the pre-cooked (85-90° C.) chickpea, soybean, pea, mung bean, and lentil based-protoleogles was higher viscoelastic than standard oleogel. Additional heating of the materials showed that the texture and structural stability of the cooked (230-260° C.) protoleogles was firmer and more consistent than the standard oleogel (FIG. 13B). Examination of the different materials in connecting extruded meat segments showed that only proteoleogels from chickpea, soybean, pea, mung bean, and lentil were consistent enough to hold the extruded meat segments together. Furthermore, these protoleogles and extruded meat segments, molded into a steak-like shape formed an interconnected structure with plant-based meat fibers interconnected by the intramuscular protoleogles fat, and adhered meat segments by intermuscular protoleogles fat enabling a strong adhesive to hold the bone parts together pre and after cooking (FIG. 14).

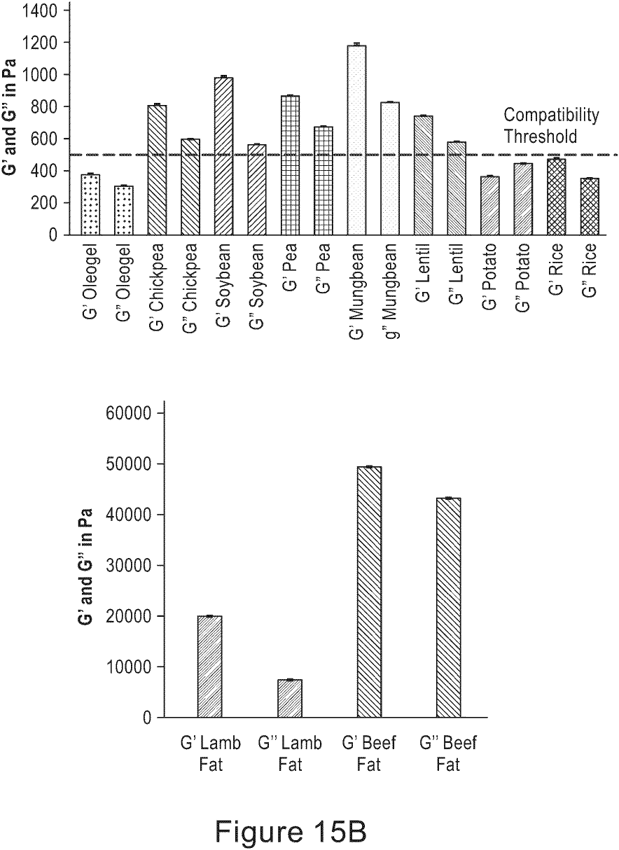

The mechanical properties needed to hold the extruded meat segments together were quantified using a HAAKE™ MARS™ one Rheometer. In this rheological experiment, shear rheology, shear moduli and yielding behavior of oleogel, protoleogles and animal raw fats was measured (FIG. 15A). Analysis has shown that chickpea, soybean, pea, mung bean, and lentil based-protoleogles increases the shear moduli and gel hardness of the plant-based fat by 2-3-fold compared to the commonly used oleogels in the pre-cooking status, while potato and rice protein did not increase the storage modulus (G′) and loss modulus (G″) (FIG. 15B). Furthermore, a minimal complex viscosity (η) was identified as the minimal complex viscosity threshold needed to hold the extruded meat segments together at 500 Pa. Mung bean showed the best rheology properties, but proteoleogels composed of chickpea, soybean, pea, and lentil proteins were similarly able of binding segments of meat analog together.

1-106. (canceled)

107. A process for producing a multi-sectional food product having an external shape and a plurality of internal sections, the process comprising simultaneously or sequentially injecting into a shaping tool having a plurality of cavities, a plurality of food components, such that each of the plurality of food components occupies a different cavity within the tool.

108. The process according to claim 107, wherein the shaping tool assembly comprises a muscle die and a fat die, wherein the muscle die shapes the internal sections of the food product, and wherein the fat die directs fat to the side faces of the product and to cavities formed between the various internal sections.

109. The process according to claim 107, wherein the extrusion is high or low moisture extrusion.

110. The process according to claim 107, the process comprising:
injecting at least one food component into a shaping tool having a plurality of spaced apart cavities within an external perimeter of the shaping tool; and
injecting at least one other food component into a space defined by a distance between the spaced apart cavities and onto the external perimeter of the cavities; to thereby obtain the product.

111. The process according to claim 107, wherein the process comprising:
injecting at least one food component into a shaping tool comprising two or more mold structures, each being arranged along a flow path of the at least one food component to fill cavities within a region defined by a shape and size of the meat-like product.

112. The process according to claim 107, the process comprising:
injecting at least one other food component into a space defined by a distance between the cavities and onto the external perimeter of the cavities filled up with the at least one food components.

113. The process according to claim 107, wherein the shaping tool comprises a plurality of material input ports, wherein each port is configured and operable to deliver into the two or more mold structures same or different food components.

114. The process according to claim 113, wherein one or more of the material input ports are positioned to allow perpendicular delivery of a food component into the mold structure.

115. The process according to claim 114, wherein one or more of the material input ports are positioned to allow peripheral delivery of a food component into the mold structure.

116. The process according to claim 107, wherein a high-moisture extruder is utilized for injection of a protein component to form aligned fibers.

117. The process according to claim 107, wherein a powder heater extruder is utilized for injection of a protein component to form aligned fibers.

118. The process according to claim 107, the process comprising:
providing a shaping tool or a system comprising same, the tool having a plurality of spaced apart cavities within an external perimeter thereof and provided with one or more muscle-like material input ports and one or more fat input ports, and optionally one or more bone cement input ports;
flowing via one or more of the muscle-like material input ports a melt mixture of protein and fat to thereby fill said cavities with the melt mixture;
flowing via one or more of the fat input ports fat to thereby fill spaces defined by distances between the cavities and onto an external perimeter of the cavities; to thereby obtain the meat-like boneless product.

119. A system for manufacturing a meat-like product, the system comprising:
a single or twin-screw extruder configured to operate at a low or high moisture, and/or low or high temperature and extrude at least one food component into a shaping tool;
a chamber configured to receive the at least one food component from said extruder and deliver same into the shaping tool; and
a shaping tool in a form of a die or a mold or an assembly thereof.

120. The system according to claim 119, wherein the shaping tool comprises two or more mold structures or dies arranged along a path of a material flow,
wherein one of the mold structures defining an external shape and size of the product and another of the mold structures having cavities within a region defined by the shape of the product.

121. The system according to claim 119, wherein the shaping tool is provided with one or more material input ports.

122. The system according to claim 119, further comprising at least one pump.

123. The system according to claim 122, wherein the at least one pump is pneumatic, a peristaltic, a positive-displacement, a centrifugal, or an axial-flow pump.

124. A method of producing a multi-sectional food product having an external shape and a plurality of internal sections, the method comprising
providing an external mold having a cavity; the external mold having at least one mold structure positioned in its internal perimeter;
injecting at least one food component into a space defined by internal walls of the at least one mold structure;
injecting at least one other food component into a space defined by the internal perimeter of the external mold and an external perimeter of the at least one mold structure;
to thereby obtain the food product.

125. A system for injection molding at least one food product, the system comprising two or more stations positioned over and in proximity of a belt system configured to move, carry and transport molds for forming the food products, the belt system being optionally temperature controlled;
wherein each of the two or more stations is provided with an extruder configured to inject a food component into a preset section of the mold, at least one of the two or more stations is provided with a high-moisture extruder enabling injection of a food component to forms aligned fibers.

126. A proteoleogel comprising at least one gelling agent, at least one oil, a protein and water.
